(19) United States
(12) Patent Application Publication
(10) Pub. No.: US 2008/0294908 A1
(43) Pub. Date: Nov. 27, 2008

(54) Recording Device, Content Key Processing Device, Recording Medium, and Recording Method

(76) Inventors: Kazutoshi Yamaguchi, Osaka (JP); Kazunori Yamaji, Osaka (JP); Hisayoshi Zenke, Hyogo (JP); Junichi Furukawa, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/658,317

(22) PCT Filed: Jul. 27, 2005
(86) PCT No.: PCT/JP2005/013760

§ 371 Date: Jun. 10, 2008

(30) Foreign Application Priority Data
Jul. 30, 2004 (JP) 2004-223163
Dec. 7, 2004 (JP) 2004-353922

(51) Int. Cl. G06F 21/24; G06F 12/14

(52) U.S. Cl. 713/189; 380/277

(57) ABSTRACT

A recording device has a content encryption unit for writing a content encrypted with a content key in a recording medium, and a key encryption unit for encrypting the content key and writing the encrypted content key in the recording medium. A content key processing device has a key decryption unit that decrypts the content key that has been encrypted and recorded in a recording medium, and a key encryption unit that re-encrypts the decrypted content key with predetermined information and writes the re-encrypted content key in the recording medium.

### TECHNICAL FIELD

The present invention relates to a recording device and a recording method for recording a content encrypted with a content key and the encrypted content key in a recording medium.

### BACKGROUND ART

In recent years, there have been ever expanding progresses in Internet delivery of contents and increasing demands for receiving paid contents by using a recording device such as a mobile terminal or the like and for storing the contents in a recording medium such as a memory card. In order to address these demands, contents providers which deliver those contents inevitably require introducing an appropriate system for firmly protecting the copy right, so as to exclude illegal copies of contents and safely deliver high quality contents.

For this reason, a conventional mobile terminal encrypts a content downloaded through the Internet by using a content key, and records the encrypted content in a data area of a recording medium, while the conventional mobile terminal encrypts the content key and records the encrypted content key is written in a protective area of the recording medium.

Moreover, Patent Document 1 has disclosed a technique in which, in the case when one device encrypts a content by using a content key so that the content is transmitted to other device, parameter information used for generating the content key is also encrypted and transmitted to the other device.

### Patent Document 1: JP-A-2000-100069

### DISCLOSURE OF INVENTION

### Problems to be Solved by the Invention

In the above-mentioned system of protecting the copy right, the current trend is that application conditions that are intended by a contents provider are added to contents. One of those application conditions is to allow contents stored in a recording medium to be reproduced only by a specific terminal device and to prevent the other terminal devices from reproducing the contents. The application of this condition, a so-called “a content bound to a device”, has come to draw public attention.

In order to meet this condition, upon receipt of contents, a conventional mobile terminal encrypts a content by using a content key that includes additional information, such as a telephone number of the mobile terminal. This method makes it possible to prevent another mobile terminal having different additional information from reproducing the content.

A prerecorded media in which contents are preliminarily written in recording media and sold or distributed is also demanding to use the application condition that allows only specific device to reproduce contents. However, since it is not possible to specify a terminal device that are allowed to reproduce at the time of prerecording the contents, the contents can not be encrypted by using additional information specific to the terminal device. For this reason, in the case when contents are recorded in a plurality of media at a time and distributed, the contents can not be bound to the specific terminal device.

The object of the present invention is to provide a recording device, a content key processing device, a recording medium and a recording method in which, even in the case when contents are preliminarily recorded in a recording media and distributed, the contents are made to be reproduced only by a specific device.

### Means to Solve the Problems

In order to solve the above-mentioned problems, the present invention has the following configuration:

A recording device of the present invention has: a content encryption unit for writing a content encrypted by using a content key in a recording medium; a key encryption unit used for encrypting the content key and writing the result in the recording medium; and a re-encryption control information generating unit that writes, in the recording medium, re-encryption control information indicating whether or not the content key needs to be re-encrypted.

By writing the re-encryption control information in the recording medium, it is possible to indicate that the content key, encrypted and written in the recording medium, should be re-encrypted.

The above-mentioned recording device may acquire the content key and the content encrypted by using the content key from a delivery server.

A content key processing device of the present invention has: a key decryption unit that decrypts an encrypted content key that is recorded in a recording medium, the encrypted content key being made by encrypting the content key for encrypting a content; and a key encryption unit that re-encrypts the content key decrypted by using predetermined information, and writes the result in the recording medium.

Here, the “predetermined information” refers to a composite key generated from medium specific information and additional information. The “additional information” refers to information specific to a device used for reproducing a content stored in the recording medium. For example, in the case when the content key processing device is used for reproducing the content, the additional information is information specific to the content key processing device. In the case when another device is used for reproducing the content, the content key processing device may acquire the additional information from the other device. The “re-encrypting” refers to an encrypting process that is carried out after the encrypted content key has been decrypted. In accordance with the present invention, even in the case when the content are recorded in a recording medium and this is then distributed, the content can be made to be reproduced only by a specific device.

The content key processing device may further have: a re-encryption control unit which, when re-encryption control information that indicates whether or not the content key needs to be re-encrypted is stored in a recording medium, acquires the re-encryption control information indicating whether or not the content key needs to be re-encrypted from the recording medium and determines whether or not a re-encrypting process is required, and only when it is determined that the re-encrypting process is required, the re-encryption control unit controlling the key decryption unit to decrypt the encrypted content key, and then controlling the key encryption unit so as to re-encrypt the content key; and a re-encryption control information modifying unit which, in the case when the content key has been re-encrypted, rewrites the re-encryption control information into the content indicating re-encryption is not needed, and writes the resulting re-encryption control information in the recording medium.

Moreover, the content key processing device may further have: a re-encryption control unit which determines whether or not the re-encryption control information indicating whether or not a re-encrypting process for the content key is required is stored in the recording medium, and only when the re-encryption control information has been stored, re-encryption control unit controlling the key decryption unit so as to decrypt the encrypted content key, and then controlling the key encryption unit so as to re-encrypt the content key; and a re-encryption control information modifying unit which, in the case when the content key has been re-encrypted, erases the re-encryption control information from the recording medium. In accordance with this invention, by reading the re-encryption control information, it becomes possible to determine whether or not the re-encrypting process is required, and consequently to prevent wasteful power consumption.

The content key processing device may further have a content decryption unit that decrypts the content, and a reproducing unit for reproducing the decrypted content.

A recording medium of the present invention has: a content key which is used for encrypting a content and has been encrypted, and re-encryption control information indicating whether or not the content key needs to be re-encrypted. Preferably, the recording medium stores the re-encryption control information in a data area that is readable and writable regardless of the result of mutual authentication or in a protective area that is readable and writable only when mutual authentication is succeeded.

A recording method of the present invention has the steps of: writing a content encrypted by using a content key in a recording medium; encrypting the content key and writing the encrypted content key in the recording medium; and writing re-encryption control information indicating whether or not the content key needs to be re-encrypted in the recording medium.

The recording method in accordance with another aspect of the present invention has the steps of: decrypting an encrypted content key recorded in a recording medium, the encrypted content key being made by encrypting the content key for encrypting a content; and re-encrypting the decrypted content key by using predetermined information and writing it in the recording medium.

In the recording method in accordance with still another aspect of the present invention, a re-encryption control information indicating whether or not the content key needs to be re-encrypted is stored in the recording medium. This method may have the steps of: acquiring the re-encryption control information from the recording medium and determining whether or not a re-encrypting process is required for the content key; only when it is determined that a re-encrypting process is required, executing the step of decrypting the content key that has been encrypted and recorded in the recording medium and the step of re-encrypting the decrypted content key by using predetermined information and writing the re-encrypted content key in the recording medium; and in the case when the content key has been re-encrypted, rewriting the re-encryption control information into the content indicating that re-encryption is not needed, and writing the resulting re-encryption control information in the recording medium.

The recording method in accordance with the other aspect of the present invention may have the steps of: determining whether or not re-encryption control information indicating whether or not a re-encrypting process for the content key is required is stored in the recording medium; only when the re-encryption control information has been stored, executing the step of decrypting the content key that has been encrypted and recorded in the recording medium and the step of re-encrypting the decrypted content key by using predetermined information and writing the re-encrypted content key in the recording medium; and in the case when the content key has been re-encrypted, erasing the re-encryption control information from the recording medium.

### EFFECTS OF THE INVENTION

In accordance with the present invention, it is possible to provide a recording device, a content key processing device, a recording medium and a recording method, which advantageously achieve a system in which, even in the case when the recording media which stores a content preliminarily recorded by the recording device is distributed, only a specific device can reproduce the content.

Moreover, in accordance with the present invention, it is possible to achieve a recording device, a content key processing device, a recording medium and a recording method, which execute the above-mentioned processes in a short period of time.

### BRIEF DESCRIPTION OF DRAWINGS

FIG. 1 is a block diagram showing an inner structure which is of a first recording device and a recording medium, and which is required when the first recording device writes a content in the recording medium in an embodiment 1 of the present invention.

FIG. 2 is a block diagram showing an inner structure which is of a second recording device and a recording medium, and which is required when the second recording device re-encrypts a content key and writes the content key in the recording medium in the embodiment 1 of the present invention.

FIG. 3 is a block diagram showing an inner structure which is of the second recording device and a terminal device, and which is required when the second recording device acquires additional information from the terminal device in the embodiment 1 of the present invention.

FIG. 4 is a block diagram showing an inner structure which is of a terminal device and a recording medium, and which is required when the terminal device reproduces the content in the embodiment 1 of the present invention.

FIG. 5 is a block diagram showing an inner structure which is of a first recording device and a recording medium, and which is required when the first recording device writes a content in the recording medium in an embodiment 2 of the present invention.

FIG. 6 is a block diagram showing an inner structure which is of a second recording device and a recording medium, and which is required when the second recording device re-encrypts a content key and writes the content key in the recording medium in the embodiment 2 of the present invention.

FIG. 7 is a block diagram showing an inner structure which is of a second recording device and a recording medium, and which is required when the second recording device reproduces a content in the embodiment 2 of the present invention.

FIG. 8 is a block diagram showing an inner structure which is of a first recording device, a delivery server and a recording medium, and which is required when the first recording device acquires contents from the delivery server in an embodiment 3 of the present invention.

### REFERENCE NUMERALS

1 Recording medium
2 ROM area
3 Recording medium ID
4 Mutual authentication key
5 Protective area
6 Encrypted content key
6a Re-encrypted content key
7 Data area
8 Encrypted content
9 Re-encryption control information
10, 10a First recording device
11, 21, 31 Interface unit
12, 22, 32 Mutual authentication processing unit
13, 23, 33 Medium specific information
14, 24, 34 Device key
15, 38 Key encryption unit
16 Content key
17 Content encryption unit
18 Re-encryption control information generating unit
19 Content
20 Reproducing unit
26, 36 Key composing unit
29, 39 Key decryption unit
30, 30a Second recording device
35 Additional information
37 Composite key
41 Re-encryption control unit
42 Re-encryption control information modifying unit
43 Content decryption unit
51 Terminal device
52, 53 Communication unit
58 Content recording unit
120 Delivery server

### BEST MODE FOR CARRYING OUT THE INVENTION

Embodiments specifically showing the best mode for carrying out the invention are described below with reference to the drawings.

### Embodiment 1

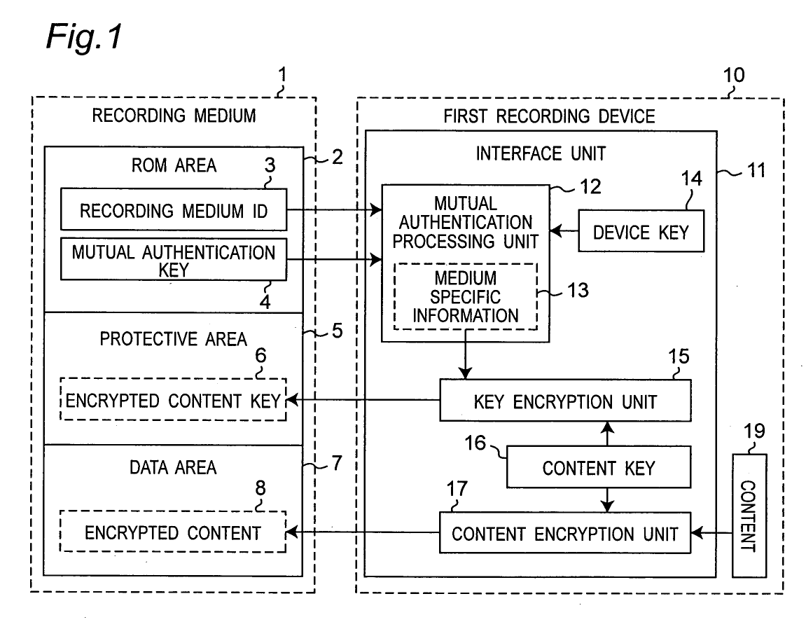

Referring to FIGS. 1 to 4, the following description will discuss a recording device, a content key processing device, a recording medium and a recording method in accordance with embodiment 1 of the present invention.

(1) Writing a Content and a Content Key by the First Recording Device

FIG. 1 shows an inner structure of a first recording device 10 and a recording medium 1. FIG. 1 mainly indicates a structure that is required when the first recording device 10 writes a content 19 in the recording medium 1.

In the present embodiment, the first recording device 10 is a recording device that is assumed to be used by a contents provider that sells and distributes contents. For example, the first recording device 10 is a personal computer. In contrast, the second recording device, which will be described later, is a content key processing device that is assumed to be used in a shop in which recording media are mainly sold. For example, the second recording device is a personal computer. The recording medium 1 is a semiconductor memory that is sold in a shop.

The recording medium 1 has a ROM area 2 that is only readable, a protective area 5 that is readable and writable only upon success of mutual authentication and a data area 7 that is readable and writable regardless of the result of mutual authentication. A recording medium ID 3 and a mutual authentication key 4 are stored in the ROM area 2.

The first recording device 10 has an interface unit 11 that is connected to the recording medium 1. The interface unit 11 includes a mutual authentication processing unit 12 that performs a mutual authentication process with a recording medium 1 that has been connected, a key encryption unit 15 that encrypts a content key 16 that is a key used for encrypting a content and a content encryption unit 17 that encrypts a content 19. The interface unit 11 further stores a device key 14 and a content key 16 in a built-in storage area.

The content 19 is data of, for example, music, an animation, a still image or a game, and is stored in a predetermined storage area of the first recording device 10.

The following description will discuss a sequence of processes in which the first recording device 10 writes the content 19 in the recording medium 1. When the recording medium 1 is connected to the first recording device 10, the mutual authentication processing unit 12 of the first recording device 10 generates medium specific information 13 from a recording medium ID 3 and a mutual authentication key 4 of the recording medium 1 and a device key 14 of the first recording device 10, and carries out a mutual authentication process between the recording medium 1 and the first recording device 10.

When the mutual authentication has been successfully completed, the key encryption unit 15 generates an encrypted content key 6 by encrypting the content key 16 with the medium specific information 13, and writes the encrypted content key 6 in the protective area 5 of the recording medium 1. Moreover, the content encryption unit 17 generates an encrypted content 8 by encrypting the content 19 with the content key 16, and writes the encrypted content 8 in the data area 7 of the recording medium 1.

The recording medium 1 in which the encrypted content key 6 and the encrypted content 8 have been written in this manner by the contents provider is then delivered to a shop. Moreover, in the shop, the content key of the recording medium 1 is re-encrypted by the second recording device. The following description will discuss the structure and operations of the second recording device.

(2) Re-Encrypting a Content Key by the Second Recording Device

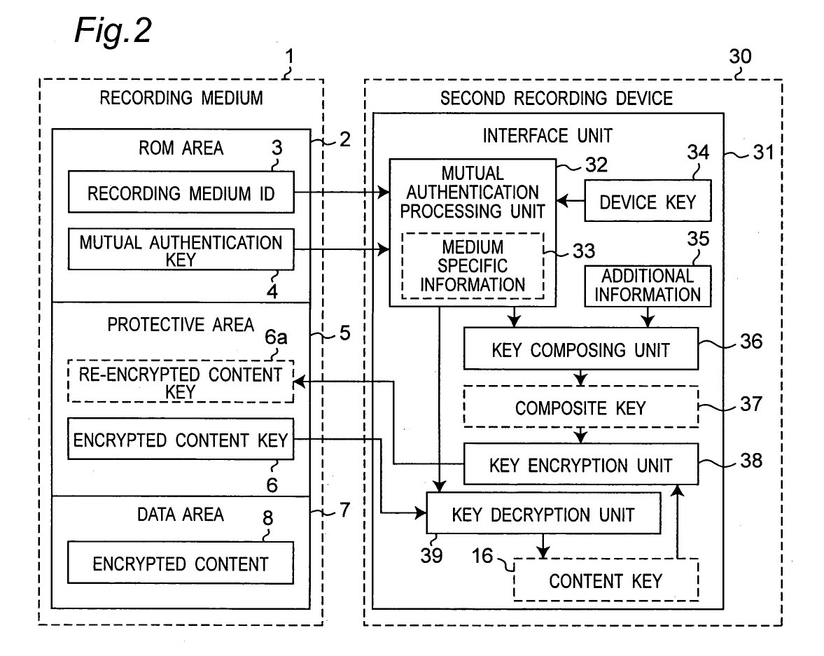

FIG. 2 shows an inner structure of the second recording device 30 and the recording medium 1. In FIG. 2, units having the same functions as those in FIG. 1 are indicated by the same reference numerals to show that they are identical to each other. FIG. 2 mainly shows a structure required when the second recording device 30 re-encrypts the content key 16 and writes the re-encrypted content key in the recording medium 1.

The second recording device 30 has an interface unit 31 connected to the recording medium 1. The interface unit 31 includes a mutual authentication processing unit 32 that carries out a mutual authentication process with the recording medium 1, a key composing unit 36 that generates a composite key 37 by using a medium specific information 33 and an additional information 35, a key encryption unit 38 that encrypts the content key 16 by using the composite key 37 and a key decryption unit 39 that reads the encrypted content key 6 from the recording medium 1 and decrypts the key.

The interface unit 11 further stores a device key 34 and the additional information 35 in a built-in storage area.

The additional information 35 is information specific to a terminal device that is allowed to reproduce the content 19. Here, the “information specific to the terminal device” may be information specific to each of individual terminal devices or information specific to a predetermined group of terminal devices. For example, the information may be an ID that is specific to a terminal device such as a cellular phone, a serial number, or a service number such as a telephone number, or may be a type of device, a manufacturer, a contents provider or a communication company, that is in common within a predetermined group of terminal devices such as cellular phones. The second recording device 30 preliminarily acquires the additional information 35 from the terminal device.

Next, the following description will discuss a sequence of processes in which the second recording device 30 writes the re-encrypted content key 6a in the recording medium 1. When the recording medium 1 is connected to the second recording device 30, the mutual authentication processing unit 32 of the second recording device 30 generates medium specific information 33 from a recording medium ID 3 and a mutual authentication key 4 in the ROM area 2 of the recording medium 1 as well as from a device key 34 stored in the interface unit 31, and carries out a mutual authentication process between the recording medium 1 and the second recording device 30.

When the mutual authentication has been successfully completed, the key decryption unit 39 reads the encrypted content key 6 which has written in the protective area 5 of the recording medium 1 by the first recording device 10, and decrypts the encrypted content key 6 by using the medium specific information 33 to obtain the content key 16.

Next, the key composing unit 36 composes the medium specific information 33 and the additional information 35 to generate a composite key 37. The key encryption unit 38 re-encrypts the decrypted content key 16 by using the composite key 37 to overwrite (re-write) the re-encrypted content key in the protective area 5 of the recording medium 1 as the re-encrypted content key 6a.

In this manner, the encrypted content key 6 of the recording medium 1 is rewritten into the re-encrypted content key 6a by the second recording device 30. This rewriting process is carried out before the recording medium 1 has been passed from the shop to the user having a terminal device 51.

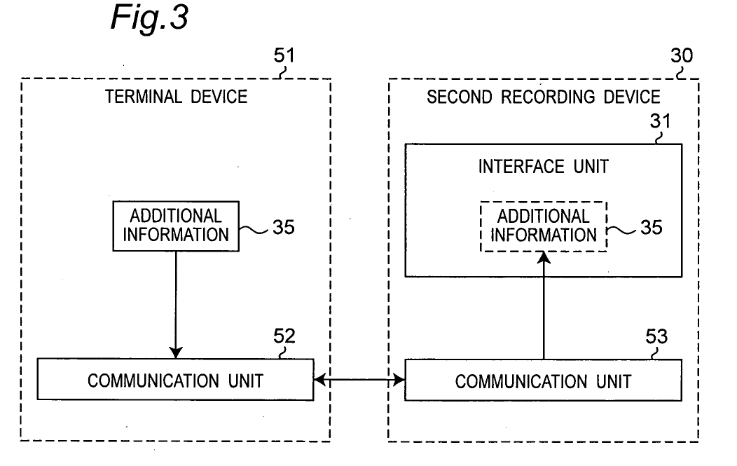

Next, referring to FIG. 3, the following description will discuss a sequence of processes in which the second recording device 30 acquires additional information 35 from the terminal device 51. In the present embodiment, the terminal device 51 is used for reproducing the content. For example, the terminal device 51 is a mobile terminal such as a cellular phone possessed by the user. The acquiring process of the additional information 35 shown in FIG. 3 is carried out before the second recording device 30 re-encrypts the encrypted content key 6.

The terminal device 51 has the additional information 35 for discriminating itself from another terminal device, and a communication unit 52 that exchanges information with the second information device 30 through cables or radio. The second recording device 30 has a communication unit 53 that exchanges information with the terminal device 51 through cables or radio.

When the terminal device 51 is connected to the second recording device 30, the second recording device 30 requests the terminal device 51 to pass the additional information 35 through the communication unit 53. Upon receipt of the request from the second recording device 30, the terminal device 51 transmits the additional information 35 in the terminal device 51 to the second recording device 30 through the communication unit 52. The second recording device 30 receives the additional information 35 through the communication unit 53, and stores it in the interface unit 31.

In FIG. 3, the communication units 52 and 53 of the terminal device 51 and the second recording device 30 are connected to each other through cable or radio. The communication units 52 and 53, however, may be connected to each other through the Internet by means of a dial-up connection using the telephone line, ADSL using LAN connection, or optical communication connection.

In this manner, firstly, the second recording device 30 acquires the additional information 35 of the terminal device 51 in the shop to re-encrypt the encrypted content key 6 by using the additional information 35, and records the re-encrypted content key in the recording medium 1. Then, the recording medium 1 is delivered to the user having the terminal device 51. Thus, the content stored in the recording medium 1 is reproduced by the terminal device 51 on the user side. The following description will discuss the structure and operations of the terminal device 51.

(3) Reproducing the Content by the Terminal Device 51

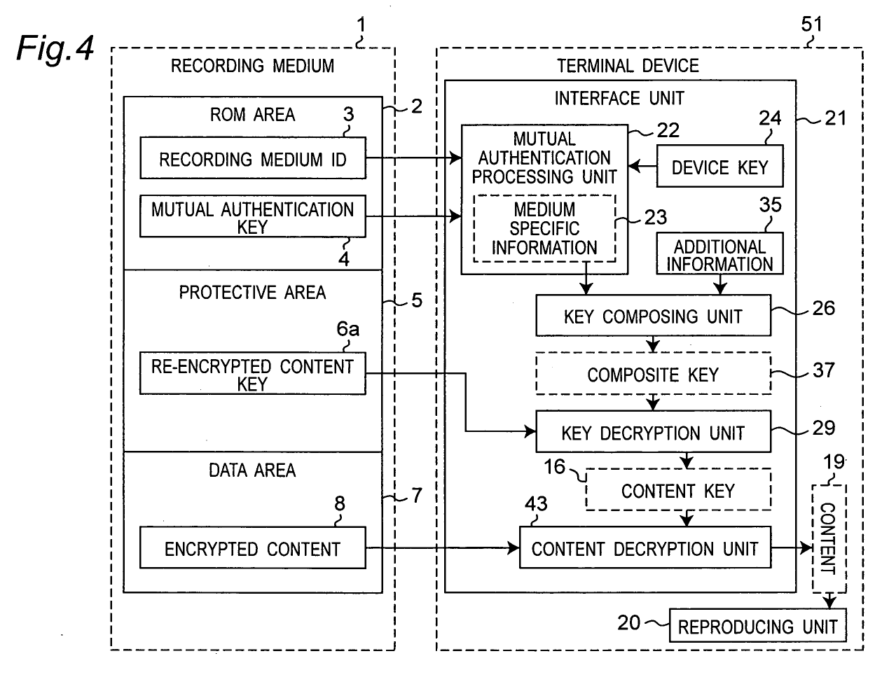

FIG. 4 shows an inner structure of the terminal device 51 and the recording medium 1. FIG. 4 mainly indicates the structure required when the terminal device 51 reproduces the content 19.

In addition to the communication unit 52 of FIG. 3, the terminal device 51 has an interface unit 21 that is connected to a recording medium 1. The interface unit 21 includes a mutual authentication processing unit 22 that carries out a mutual authentication process with the recording medium 1, a key composing unit 26 that generates a composite key 37 by composing the medium specific information 23 and additional information 35, a key decryption unit 29 that decrypts a re-encrypted content key 6a written in the recording medium 5 and a content decryption unit 43 that decrypts the encrypted content 8 and a reproducing unit 20 that reproduces the decrypted the content 19.

The interface unit 21 further stores the device key 24 and the additional information 35 in a built-in storage area.

Next, referring to FIG. 4, the following description will discuss a sequence of processes in which the terminal device 51 reproduces the encrypted content 8 stored in the recording medium 1. When the recording medium 1 is connected to a terminal device 51, the mutual authentication processing unit 22 of the terminal device 51 generates medium specific information 23 from the recording medium ID 3 and the mutual authentication key 4 in the ROM area 2 of the recording medium 1 and a device key 24 stored in the interface unit 21, and carries out a mutual authentication process between the recording medium 1 and the terminal device 51.

When the mutual authentication has been successfully completed, the key composing unit 26 composes the medium specific information 23 and the additional information 35 to generate the composite key 37.

The key decryption unit 29 reads the re-encrypted content key 6a from the protective area 5 of the recording medium 1, and decrypts it by using the composite key 37 to obtain the content key 16. Then, the content decryption unit 43 reads the encrypted content 8 from the data area 7 of the recording medium 1, and decrypts it by using the content key 16. The reproducing unit 20 reproduces the content 19 thus obtained through the decrypting process.

As described above, in prerecorded media field, in which contents are preliminarily written in the media and then the media are sold or distributed, when the first recording device 10 writes a content in the recording medium 1, a terminal device 51 that reproduces the content is not specified, so that the additional information 35 of the terminal device 51 can not be used. In the present embodiment, however, at the time when the terminal device 51 has been specified, the second recording device 30 re-encrypts the content key 16 by using the additional information 35 of the terminal device 51 to write the re-encrypted content key in the recording medium 1. For this reason, only the terminal device 51 having the same additional information 35 as additional information 35 which was used for re-encrypting the content key 16, and only the second recording device 30 that has acquired the additional information 35 used for re-encrypting the content key 16, are allowed to reproduce the content 19 of the recording medium 1. In other words, even when the recording medium 1 is connected to another terminal device having different additional information, the other terminal device is not allowed to decrypt the re-encrypted content key 6a and fails to reproduce the content 19.

In the present embodiment, even in the case of prerecorded media that are formed by preliminarily writing contents in the recording media and then are sold or distributed, the content can be made to be reproduced only by a specific terminal device, through the second recording device 30.

In the present embodiment, it is not necessary to re-encrypt the encrypted content 8. Since the re-encryption process can be completed only by re-encrypting the content key 16, it is possible to shorten the processing time.

Here, the elements inside each of interface units of the first recording device 10, the second recording device 30 and the terminal device 51 may be achieved by either of individual hardware and software.

Moreover, the content 19 may be audio information, video information, data that can be used by computers or data having a mixture of these, and the substances of the content 19 are not limited.

With respect to the recording medium 1, any kinds of devices, such as a semiconductor memory, an optical disk or a magnetic disk, may be used without limitation.

The additional information 35 may be information such as an ID or a serial number that are recorded in a ROM or the like of the terminal device 51 upon production thereof, or may be information such as a telephone number that is recorded in the terminal device 51 when the recording medium 1 is handed to the user.

In the present embodiment, the additional information 35 of the terminal device 51 is transferred to the second recording device 30 through the communication units 52 and 53. The additional information 35 of the terminal device 51, however, may be inputted to the second recording device 30 through a keyboard that is connected to the second recording device 30.

Moreover, the second recording device 30 is not limited to the content key processing device possessed by a shop in which the recording media are sold. The second recording device 30 may be a content key processing device such as a personal computer possessed by the user who purchases the recording medium.

Furthermore, the second recording device 30 may differ from a personal computer, and may be a mobile terminal that is allowed to reproduce the content 19. In this case, instead of allowing the second recording device 30 to acquire additional information 35 from the terminal device 51, the content key 16 is re-encrypted by using additional information specific to the second recording device 30. Then, the content 19 may be reproduced by the second recording device 30.

Here, the re-encrypting of the content key 16 is executed when the recording medium 1 is inserted into the second recording device 30.

### Embodiment 2

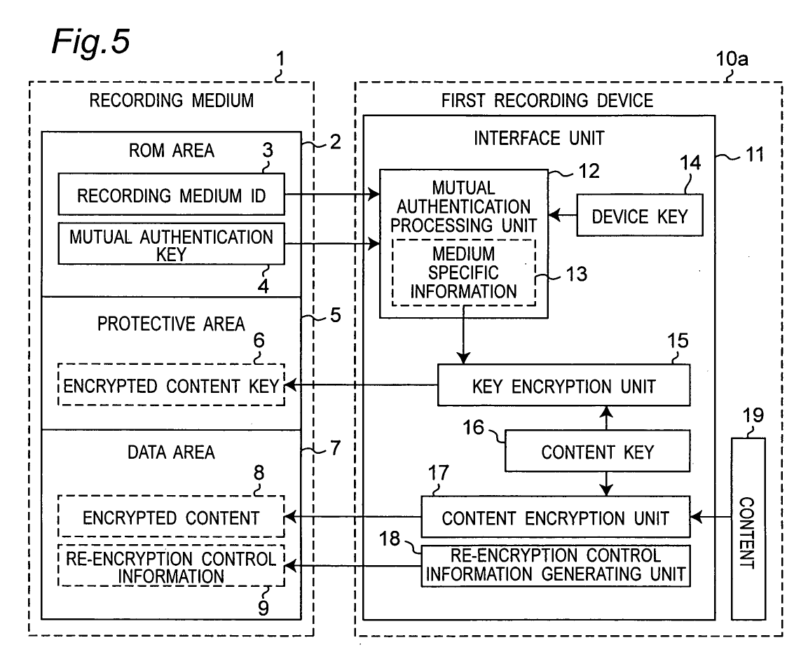

Referring to FIGS. 5 to 7, the following description will discuss another example of a recording device, a content key processing device, a recording medium and a recording method. In FIGS. 5 to 7 of an embodiment 2, elements having the same functions as those of FIGS. 1 to 4 in the embodiment 1 are indicated by the same reference numerals to show that they are identical to each other.

(1) Writing a Content by the First Recording Device

FIG. 5 shows an inner structure of a first recording device 10a and a recording medium 1 in accordance with the embodiment 2 of the present invention. FIG. 5 mainly indicates a structure that is required when the first recording device 10a writes a content 19 in the recording medium 1.

In the present embodiment, the first recording device 10a is a recording device that is assumed to be used by a contents provider that sells and distributes contents. For example, the first recording device 10a is a personal computer. In contrast, the second recording device, which will be described later, is a content key processing device that is assumed to be used by the user. For example, the second recording device is a mobile terminal such as a cellular phone that is allowed to reproduce the content 19. The recording medium 1 is a semiconduct or memory to be sold in a shop.

In addition to the structure of the embodiment 1, the first recording device 10a of the embodiment 2 further has a re-encryption control information generating unit 18 that writes re-encryption control information 9 in a data area 7 of the recording medium 1. The re-encryption control information 9 is information that indicates whether or not the re-encrypting of the content key 16 is required.

After mutual authentication with the recording medium 1, the first recording device 10a of the embodiment 2 writes the encrypted content key 6 and the encrypted content 8 in the recording medium 1 by the same sequence as that of the embodiment 1. In this case, the re-encryption control information generating unit 18 generates re-encryption control information 9 indicating that re-encryption is required, and writes the re-encryption control information 9 in the data area 7 of the recording medium 1.

The recording medium 1 in which the encrypted content key 6, the encrypted content 8 and the encryption control information 9 have been thus written on the contents provider side is delivered to the user who has the second recording device directly or through a shop. Then, the re-encrypting process of the content key of the recording medium 1 and the reproducing process of the content are carried out by the second recording device. The following description will discuss the structure and operations of the second recording device.

(2) Re-Encrypting the Content Key and Overwriting Re-Encryption Control Information by the Second Recording Device

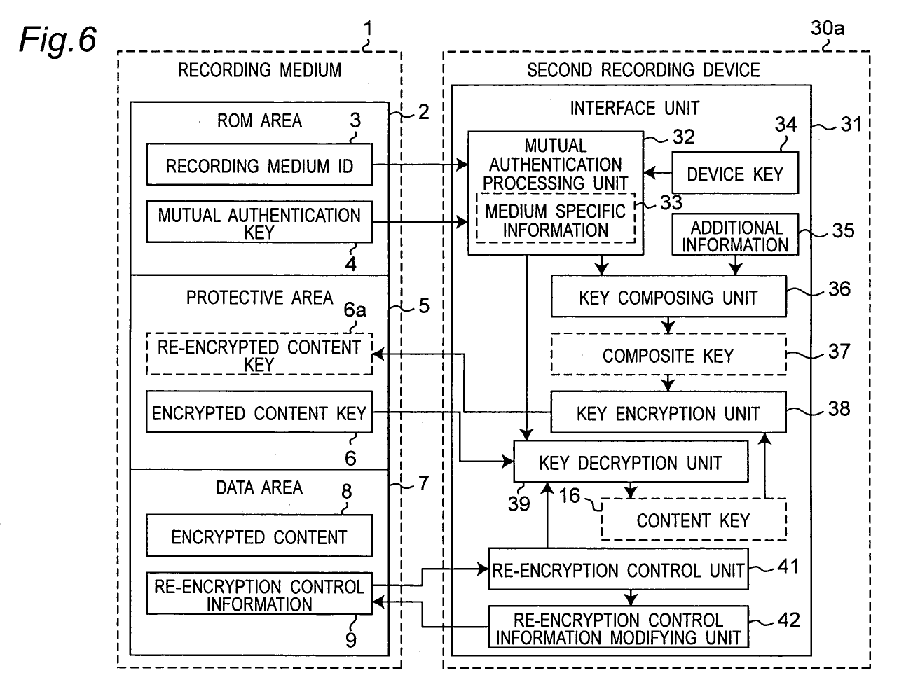

FIG. 6 shows an inner structure of the second recording device 30a and a recording medium 1. FIG. 6 mainly indicates the structure that is required when the recording device 30a re-encrypts the content key 16 and writes it in the recording medium 1.

In addition to the structure of embodiment 1, the second recording device 30a of the embodiment 2 has a re-encryption control unit 41 that reads the re-encryption control information 9 from the recording medium 1 and determines whether or not a re-encrypting process is required, and a re-encryption control information modifying unit 42 that rewrites the contents of the re-encryption control information 9.

The additional information 35 of the present embodiment may be information such as an specific ID and a serial number that are recorded in a ROM or the like of the second recording device 30a upon production thereof, or may be information such as a telephone number to be recorded in the second recording device 30a when the recording medium 1 having the encrypted content 6 recorded therein is handed to the user from a contents provider or a shop.

The following description will discuss a sequence of processes in which the second recording device 30a writes the re-encrypted content key 6a and the re-encryption control information 9 in the recording medium 1. When the recording medium 1 is connected to the second recording device 30a, the re-encryption control unit 41 reads the re-encryption control information 9 from the data area 7 of the recording medium 1, and determines whether or not a re-encrypting process of the content key is required based on the re-encryption control information 9.

Only in the case when the re-encryption control unit 41 has determined that the re-encrypting process is required, the second recording device 30a executes the re-encrypting process of the content key 16. In other words, the mutual authentication processing unit 32 executes mutual authentication with the recording medium 1, and when the mutual authentication has been successfully completed, the second recording device 30a rewrites the encrypted content key 6 into a re-encrypted content key 6a, in the same manner as embodiment 1.

Moreover, the re-encryption control information modifying unit 42 converts contents of the re-encryption control information 9 into contents indicating that the re-encryption process is not required, and overwrites the resulting re-encryption control information 9 in the data area 7 of the recording medium 1. Additionally, instead of overwriting the re-encryption control information 9 indicating that the re-encryption process is not required on the recording medium 1, the re-encryption control information modifying unit 42 may erase the re-encryption control information 9 from the recording medium 1.

(3) Reproducing a Content by the Second Recording Device

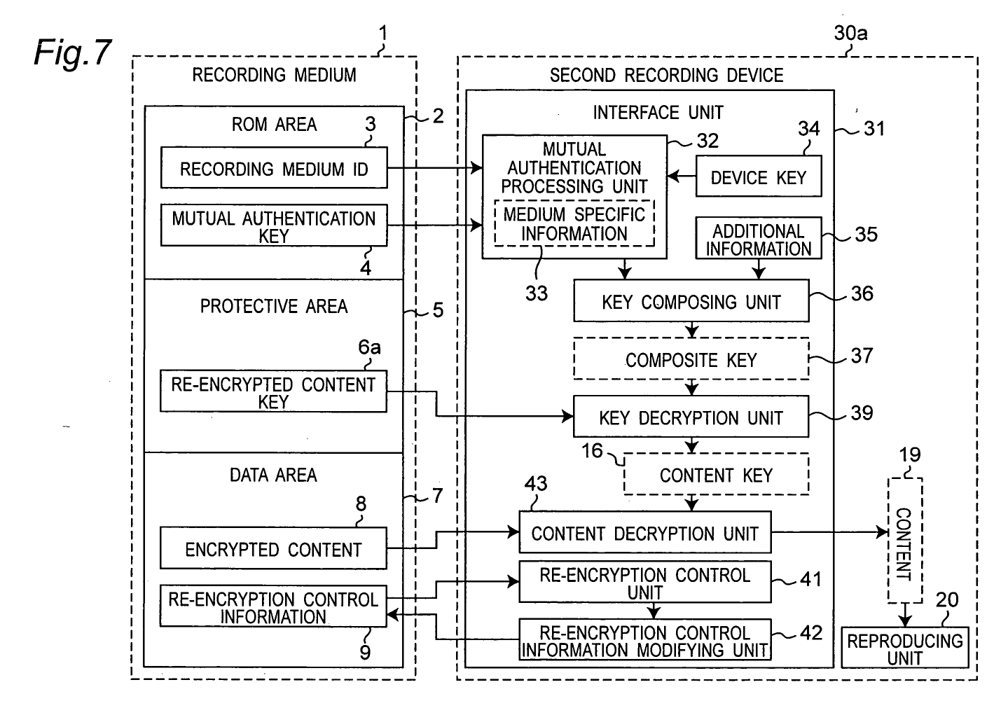

FIG. 7 shows an inner structure of the second recording device 30a and the recording medium 1, which is required when the second recording device 30a reproduces the content in the present embodiment. Referring to FIG. 7, the following description will discuss a sequence of processes in which the recording device 30a reproduces the content 19 from the recording medium 1.

When the recording medium 1 is connected to the second recording device 30a, the re-encryption control unit 41 of the second recording device 30a reads the re-encryption control information 9 from the data area 7 of the recording medium 1, and determines whether or not a re-encrypting process of the content key is required.

When the re-encryption control unit 41 has determined that no re-encryption is required, or when the re-encryption control information 9 has been erased from the recording medium 1, the second recording device 30a does not execute a re-encrypting process on the content key.

In the case when the re-encryption control unit 41 has determined that no re-encryption is required, the second recording device 30a decrypts the re-encrypted content key 6a. For this reason, the mutual authentication processing unit 32 executes mutual authentication with the recording medium 1, and when the mutual authentication has been successfully completed, the second recording device 30a reads the re-encrypted content key 6a stored in the protective area 5 of the recording medium 1 in the same manner as the terminal device 51 of embodiment 1. Thus, the key decryption unit 39 decrypts the re-encrypted content key 6a by using the composite key 37 containing the additional information 35 to acquire the content key 16.

The content decryption unit 43 decrypts the encrypted content 8 stored in the data area 7 of the recording medium 1 by using the content key 16, so that the reproducing unit 20 reproduces the content 19.

In this manner, in accordance with the present embodiment, the second recording device 30a preliminarily reads the re-encryption control information 9, and after determining whether or not the re-encryption is required, executes the corresponding process. Therefore, the content key 16 can be efficiently re-encrypted. For this reason, the present embodiment is suitably applied to a system in which the second recording device 30a is prepared as a device having small power consumption, such as a mobile terminal.

In accordance with the present embodiment, when the first recording device 10a writes the encrypted content 8 and the encrypted content key 6 in the recording medium 1, the first recording device 10a writes the re-encryption control information 9 having the contents that the re-encryption of the encrypted content key 6 is required, in the recording medium. For this reason, when the recording medium 1 is inserted into the second recording device 30a, the second recording device 30a can rewrite the encrypted content key 6 to the re-encrypted content key 6a based on the re-encryption control information 9 indicating that the re-encryption is required. At this time, the second recording device 30a rewrites the re-encryption control information 9 such as indicating that the re-encrypting process is not required, or erases the re-encryption control information 9 from the recording medium 1. Thereafter, even when the recording medium 1 is connected any other recording device, the other recording device cannot rewrite the encryption content key 6 because the other recording device can not determine that the re-encrypting is required based on the re-encryption control information.

In this manner, in accordance with the present embodiment, even in the case when a content is written in the recording medium 1 in a stage where the first recording device 10a has not specified an device that is allowed to reproduce the content, the content can be made to be reproduced only by the second recording device.

In the present embodiment, it is not necessary to re-encrypt the encrypted content 8. Since it is only necessary to re-encrypt the content key 16 to complete the process, the process can be finished in a short period of time.

Here, instead of writing the re-encryption control information 9 in the data area 7 of the recording medium 1, it may be written in the protective area 5.

Moreover, the recording medium 1 is not particularly limited to the kinds thereof and various kinds of media, such as semiconductor memories, optical disks or magnetic disks, may be used as the recording medium 1.

Here, in the present embodiment, the elements inside each of interface units of the first recording device 10a and the second recording device 30a may be achieved by either of individual hardware and software.

### Embodiment 3

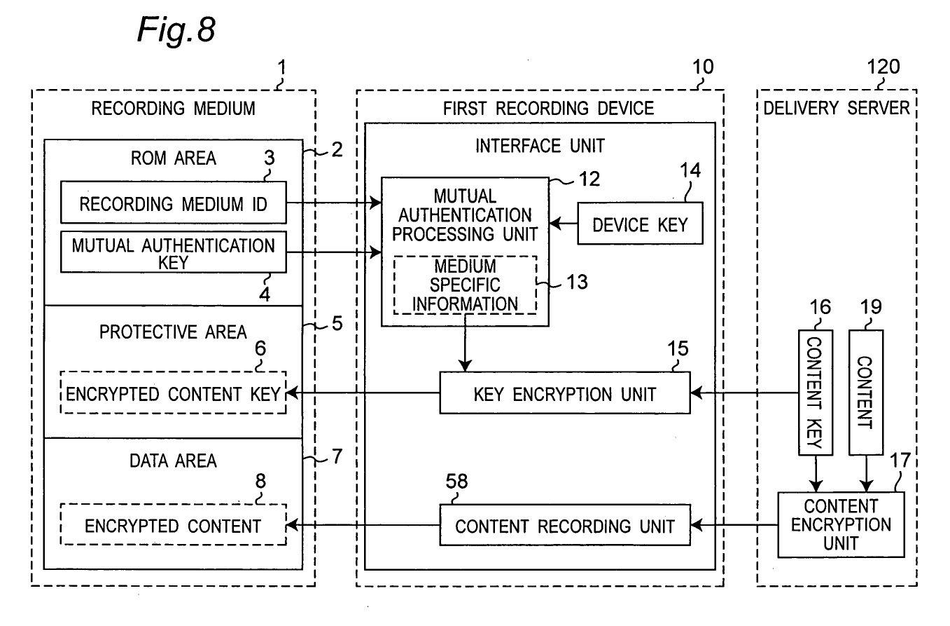

In embodiment 1 or embodiment 2, the first recording device 10 or 10a may acquire the content 19 from a delivery server that is connected to the first recording device 10 or 10a through a network. FIG. 8 shows an inner structure of a first recording device 10, a delivery server 120 and a recording medium 1. FIG. 8 mainly indicates a structure that is required when the first recording device 10 acquires contents from the delivery server 120.

The delivery server 120 has a content key 16, a content 19 and a content encryption unit 17 that generates an encrypted content 8 by encrypting the content 19 by using the content key 16.

The first recording device 10 receives the content key 16 and the encrypted content 8 respectively from the delivery server 120. The first recording device 10, which has a content recording unit 58, records the encrypted content 8 thus received in the data area 7 of the recording medium 1. The key encryption unit 15 encrypts the content key 16 by using medium specific information 13, and writes the encrypted content key 6 generated in the protective area 5 of the recording medium 1.

In this manner, the first recording device 10 may acquire the encrypted content 8 and the content key 16 from the delivery server 120 having various contents.

Here, although the first recording device 10 of FIG. 8 does not include the re-encryption control information generating unit, the first recording device of the present embodiment may have a re-encryption control information generating unit 18 as shown in FIG. 5 of the embodiment 2. In this case, the corresponding second recording device has preferably the same structure as shown in FIG. 6 or FIG. 7.

### INDUSTRIAL APPLICABILITY

The present invention is applied to a recording device and a recording method which record a content encrypted by a content key and the encrypted content key in a recording medium.

1-14. (canceled)

15. A recording device comprising:
a content encryption unit that writes an encrypted content in a recording medium, the encrypted content being made by encrypting a content with a content key;
a key encryption unit that makes an encrypted content key by encrypting the content key to write the encrypted content key in the recording medium; and
a re-encryption control information generating unit that writes, in the recording medium, re-encryption control information indicating whether or not the content key needs to be re-encrypted, the re-encryption control information enabling a specific device to reproduce the content.

16. The recording device according to claim 15, wherein the content key and the encrypted content are acquired from a delivery server.

17. A content key processing device comprising:
a re-encryption control unit that reads out a re-encryption control information from a recording medium, the recording medium storing an encrypted content made by encrypting a content, an encrypted content key made by encrypting a content key used for decrypting the encrypted content, and the re-encryption control information indicating whether or not the content key needs to be re-encrypted, the re-encryption control unit determining whether or not a re-encrypting process for a content key is required based on the re-encryption control information,
a key decryption unit that reads out only the encrypted content key from the recording medium and decrypts the encrypted content key to obtain the content key when the re-encryption control unit determines that the re-encrypting process of the content key is required; and
a key encryption unit that re-encrypts only the decrypted content key by using predetermined information to make a re-encrypted content key and write the re-encrypted content key in the recording medium when the re-encryption control unit determines that the re-encrypting process of the content key is required.

18. The content key processing device according to claim 17, further comprising:
a re-encryption control information modifying unit which converts contents of the re-encryption control information into contents indicating that re-encryption is not required and writes the resulting re-encryption control information in the recording medium when the content key has been re-encrypted.

19. The content key processing device according to claim 17, further comprising:
a re-encryption control information modifying unit which erases the re-encryption control information from the recording medium when the content key has been re-encrypted.

20. The content key processing device according to claim 17, wherein the additional information for generating predetermined information is specific to a device for reproducing the content stored in the recording medium.

21. The content key processing device according to claim 17, further comprising:
a content decryption unit that reads out the encrypted content from the recording medium and decrypts the encrypted content to obtain the content; and
a reproducing unit that reproduces the decrypted content.

22. A recording medium comprising:
an encrypted content key made by encrypting a content key used for decrypting an encrypted content made by encrypting a content, and
re-encryption control information indicating whether or not the content key needs to be re-encrypted, the re-encryption control information enabling a specific device to reproduce the content.

23. The recording medium according to claim 22, wherein the re-encryption control information is stored in a data area that is readable and writeable regardless of the result of mutual authentication or in a protective area that is readable and readable only when the mutual authentication is succeeded.
